(19) United States
(12) Patent Application Publication
(10) Pub. No.: US 2015/0212656 A1
(43) Pub. Date: Jul. 30, 2015

(54) PORTABLE APPARATUS AND METHOD FOR ADJUSTING WINDOW SIZE THEREOF

(71) Applicant: Acer Incorporated, New Taipei City (TW)

(72) Inventor: Hsuan-Wei Lin, New Taipei City (TW)

(21) Appl. No.: 14/514,409

(22) Filed: Oct. 15, 2014

(30) Foreign Application Priority Data
Jan. 29, 2014 (TW) 103103595

(51) Int. Cl. G06F 3/0481; G06F 3/0488; G06F 3/0484

(52) U.S. Cl. CPC G06F 3/0481; G06F 3/04842; G06F 3/0488

(57) ABSTRACT

A portable apparatus and a method for adjusting a window size thereof are provided. The portable apparatus includes a touch screen and a motion sensor. In the method, a touch operation performed on the touch screen is detected. When the touch operation is detected, a rotation angle and a rotation direction of the portable apparatus relative to a reference axis perpendicular to the touch screen are detected by using the motion sensor, and whether the rotation angle is over a threshold is determined. When the rotation angle is over the threshold, a size of a window displayed on the touch screen is adjusted according to a touch position of the touch operation and the rotation direction.

### CROSS-REFERENCE TO RELATED APPLICATION

This application claims the priority benefit of Taiwan application serial no. 103103595, filed on Jan. 29, 2014. The entirety of the above-mentioned patent application is hereby incorporated by reference herein and made a part of this specification.

### BACKGROUND

1. Field of the Invention

The present invention is directed to a portable apparatus and an operation method thereof and more particularly, to a portable apparatus and a method for adjusting a window size thereof.

2. Description of Related Art

With the development of technologies, electronic apparatuses, such as smart phones and tablet PCs, have become increasingly popular, and touch technologies therewith provide plentiful and humanized human-machine interaction.

Recently, the electronic apparatuses using touch screens as operation tools are gradually developed toward being equipped with large-size touch screens for the convenience of users' operations, so as to meet various demands of the users, such as document composing, email receiving and sending, web browsing, multi-media watching, or using instant message software.

However, a large-size touch screen is inconvenient for a user to hold with one hand. Referring to FIG. 1, with limitation of a palm size, partial area 12 of a touch screen 10 cannot be operated by the user with one hand. As a result, the user has to operate the touch screen with both hands, which causes difficulty and inconvenience the operations of the user.

### SUMMARY

Accordingly, the invention provides a portable apparatus and a method for adjusting a window size thereof, by which a user can adjust or zoom a window by using simple gestures and thus, can operate the portable apparatus with one hand conveniently.

The invention is directed to a method for adjusting a window size, which is adapted for a portable apparatus having a touch screen and a motion sensor. In the method, a touch operation performed on the touch screen is detected. When the touch operation is detected, a rotation angle and a rotation direction of the portable apparatus relative to a reference axis perpendicular to the touch screen are detected by using the motion sensor, and whether the rotation angle is over a threshold is determined. When the rotation angle is over the threshold, a size of a window displayed on the touch screen is adjusted according to a touch position of the touch operation and the rotation direction.

The invention is directed to a portable apparatus, including a touch screen, a motion sensor and a processor. The touch screen is configured to detect a touch operation and display a window. The motion sensor is configured to detect a rotation angle and a rotation direction of the portable apparatus relative to a reference axis perpendicular to the touch screen. The processor is coupled to the touch screen and the motion sensor and configured to determine whether the rotation angle detected by the motion sensor is over a threshold when the touch operation is detected by the touch screen and adjust a size of a window displayed on the touch screen according to a touch position of the touch operation and the rotation direction when the rotation angle is over the threshold.

Based on the above, the portable apparatus and the method for adjusting the window size thereof combine the touch operation with wobbling gestures. Thereby, the screen window can be zoomed into a range that is operable by the user with one hand, and the user can operate functions of the apparatus conveniently.

To make the above features and advantages of the invention more comprehensible, embodiments accompanied with drawings are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating a conventional large-size touch screen.

FIG. 2 is a block diagram illustrating a portable apparatus having an adjustable window according to one embodiment of the present invention.

FIG. 3 is a flowchart illustrating a method for adjusting a window size according to an embodiment of the invention.

FIG. 4 is a flowchart illustrating a method for adjusting a window size according to an embodiment of the invention.

FIG. 5A and FIG. 5B illustrate an example of adjusting a window size according to an embodiment of the invention.

FIG. 6A and FIG. 6B illustrate an example of adjusting a window size according to an embodiment of the invention.

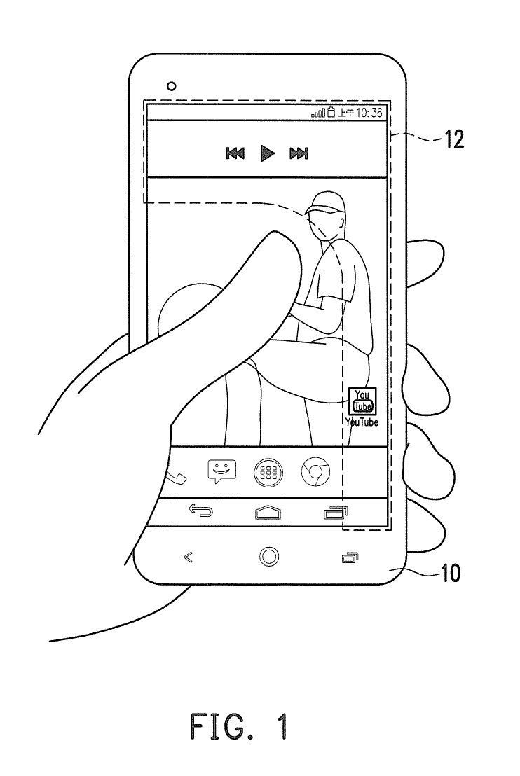

### DESCRIPTION OF EMBODIMENTS

For a large-size touch screen, an area that can be touched by a user with one hand is limited, and thus, in the invention, a size of a window may be adjusted according to a position that is touchable by one hand. The invention combines the touch operation of the user with wobbling gestures so as to determine whether the user is desired to adjust the window size. The size of the window to be adjusted is determined according to a position of a touch operation when adjusting the size of the window. A position (i.e., a position where the touch operations is performed) of the adjusted window that is the farthest away from a palm (or an edge of the screen) is still within a range that is touchable by the user, and thereby, one-hand operation can be achieved.

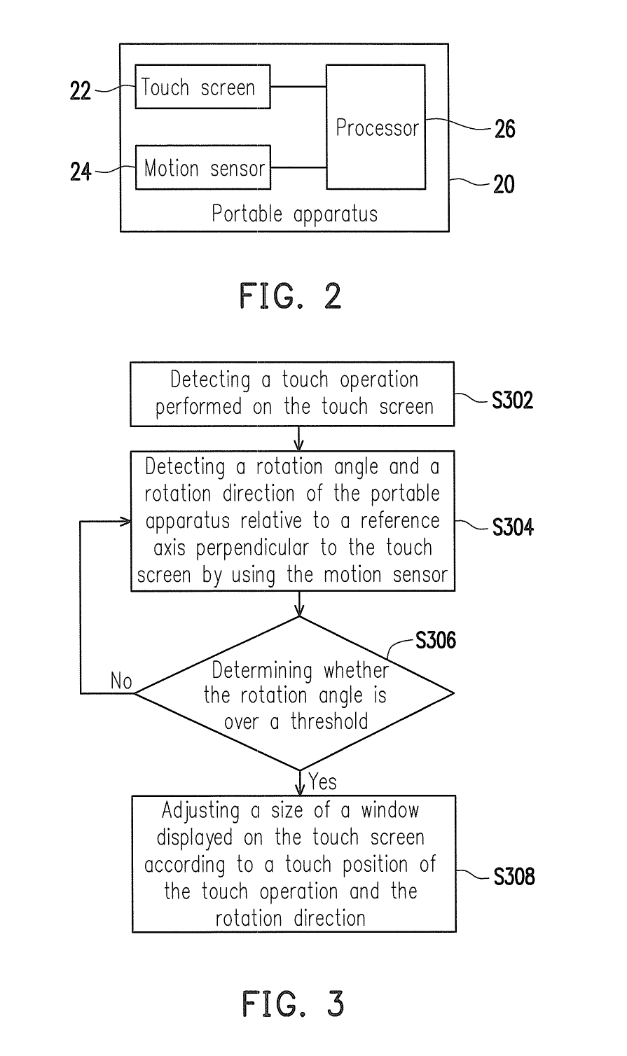

FIG. 2 is a block diagram illustrating a portable apparatus having an adjustable window according to one embodiment of the present invention. Referring to FIG. 2, a portable apparatus 20 may be, for example, any type of electronic apparatus having a touch and display capability, such as a mobile phone, a smart phone, a personal digital assistant (PDA) or a tablet PC, and the type of the portable apparatus 20 is not limited in the invention.

The portable apparatus 20 includes a touch screen 22, a motion sensor 24 and a processor 26. The touch screen 22 is an input and output interface of the portable apparatus 20, and is configured to display various types of screen frames of the portable apparatus 20 and detect a touch operation performed by the user on the screen frame. The touch screen 22 is, for example, a liquid crystal display (LCD), a light-emitting diode (LED) display, a field emission display (FED) or any other type display, which is assembled with a touch panel, such as a resistive or a capacitive touch panel, to provide both a display and a touch operation capabilities.

The motion sensor 24 is for example, a 3-axis gravity sensor (G-sensor), a magnetic sensor or a gyro sensor. The motion sensor 24 may also be a 6-axis gravity/gyro sensor combining gravity sensing and angular momentum sensing, a 6-axis gravity/magnetic sensor combining gravity sensing and magnetic sensing, or a 9-axis gravity/magnetic/gyro sensor combining gravity sensing, magnetic sensing and angular momentum sensing, which is not limited in the invention. The motion sensor 24 is configured to detect a rotation angle and a rotation direction of the portable apparatus 20 relative to a reference axis perpendicular to the touch screen 22. In one embodiment, the rotation angle may be obtained, for example, by calculating a yaw angular velocity sensed by a gryo sensor, and the yaw angular velocity is an angular velocity of the portable apparatus 20 rotating with the Z-axis perpendicular to the touch screen 22 as a center. By substituting a yaw angular velocity co in to the following formula (1), a converted rotation angle Z may be obtained.

Z=ω×(180/π)×s (1)

Therein, s represents time, and whether a value of the rotation angle Z is positive or negative represents the rotation, namely, a positive value of the rotation angle Z represents a clockwise rotation direction, while a negative value of the rotation Z represents a counterclockwise rotation direction.

The processor 26 is coupled to the touch screen 22 and the motion sensor 24. The processor 26 may be a central processing unit (CPU) having a single core or multiple cores or any other programmable microprocessor, digital signal processor (DSP), programmable controller, application specific integrated circuit (ASIC), other similar devices, or a combination of these devices utilized for general or specific application. In the present embodiment, the processor 26 may execute a computer program to perform a method for adjusting a window size provided by the invention.

In detail, FIG. 3 is a flowchart illustrating a method for adjusting a window size according to an embodiment of the invention. Referring to FIG. 2 and FIG. 3, the method of the present embodiment is adapted for the portable apparatus 20, and each step of the method of the present embodiment will be described in detail with reference to each element of the portable apparatus 20 illustrated in FIG. 2.

First, the portable apparatus 20 detects a touch operation performed by the user on the touch screen 22 by using the touch screen 22 (step S302). The aforementioned touch operation includes various kinds of gestures, such as a single-click, a double-click or a long press, or a combination thereof, which is not limited in the invention. It is to be mentioned that when the touch operation is detected by the touch screen 22, the processor 26, for example, first determines whether the touch operation is within a predetermined area displayed on the touch screen 22 so as to determine whether to continue the follow-up steps of the method of the present embodiment. The predetermined area may be, for example, a screen to be unlocked of the portable apparatus 20, an area except for a touchable object (e.g., an application icon) within a locked screen, or a screen frame of specific application (e.g., a screen frame of instant messaging software or game software). By way of limiting the touch operation within the predetermined area, the touch operation for the user to adjust the window size may be distinguished from a function initially set for the touch operation by the portable apparatus 20, and in this way, the use of the touch operation may be more flexible.

Returning to the process of FIG. 2, when the touch operation is detected by the touch screen 22, the portable apparatus 20 detects a rotation angle and a rotation direction of the portable apparatus 20 relative to a reference axis perpendicular to the touch screen 22 by using the motion sensor 24 (step S304). In one embodiment, the portable apparatus 20 drives the motion sensor 24 to detect the rotation angle and the rotation direction of the portable apparatus 20 only when the touch operation is detected by the touch screen 22. In another embodiment, the portable apparatus 20 may also continue to detect the rotation angle and the rotation direction by using the motion sensor 24. When the touch operation is detected by the touch screen 22, the processor 26 retrieves the rotation angle and the rotation direction detected thereby from the motion sensor 24 and then continues the determinations steps, but the invention is not limited thereto.

After the rotation angle and the rotation direction are detected by the motion sensor 24, the processor 26 further determines whether the rotation angle is over a threshold (step S306). The threshold, for example, ranges from 30 to 45 degrees and may be freely set by the user depending on the demand of detecting sensitivity.

When determining that the rotation angle is over the threshold, the processor 26 adjusts a size of a window displayed on the touch screen 22 according to a touch position of the touch operation and the rotation direction (step S308). Otherwise, when the processor 26 determines that the rotation angle is not over the threshold, the method returns to step S304, and the rotation angle and the rotation direction of the portable apparatus 20 are continuously detected. When adjusting the size of the window, the processor 26, for example, proportionally adjusts or zooms (i.e., the original proportion of the window is maintained) the size of the window according to a square area formed by the touch position and a side edge and a lower edge of the touch screen 22, such that the adjusted window is located within the square area and has a height identical to a height of the square area or has a width identical to a width of the square area. That is, a display range of the adjusted window does not exceed the square area, such that the user may operate with one hand conveniently.

It should be mentioned that in one embodiment, the side edge of the touch screen is, for example, a side edge having a longer distance away from the touch position, and as if the rotation angle rotated by the user in any direction (i.e., clockwise or counterclockwise) is over the threshold, the processor 26 adjusts or zooms the size of the window according to the square area formed by the touch position and the side edge and the lower edge, such that the adjusted window is located within the square area, and the height or the width of the adjusted window is identical to that of the square area. For example, if the user holds the portable apparatus 20 with his/her left hand for operation, and a position touched and operated by the user is located in the right half part of the touch screen 22, the touch position is away from the left-side edge of the touch screen 22. Thus, the processor 26 adjusts or zooms the size of the window according to the square area formed by the touch position and the left-side edge and the lower edge. Meanwhile, the adjusted window is located at the lower left of the touch screen 22, and in this way, it is just right for the user to perform the one-hand operation with his/her left hand.

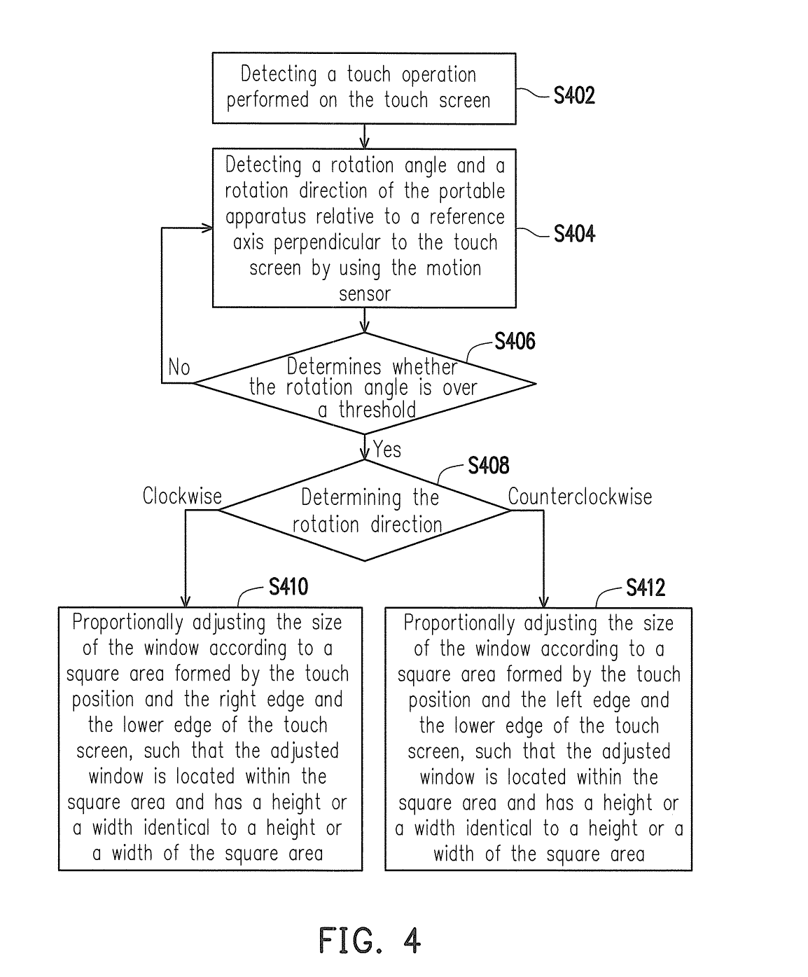

The rotation direction of the portable apparatus 20 is not limited in the embodiment above. However, in another embodiment, the square area used for adjusting the size of the window may be further determined by combining the rotation direction of the portable apparatus 20, and by doing so, the adjusted window may satisfy what is currently needed by the user. To be more detailed, FIG. 4 is a flowchart illustrating a method for adjusting a window size according to an embodiment of the invention. Referring to FIG. 4 together with FIG. 2, the method of the present embodiment is adapted for the portable apparatus 20, and each step of the method of the present embodiment will be described in detail with reference to each element of the portable apparatus 20 illustrated in FIG. 2.

First, the portable apparatus 20 detects a touch operation performed by the user on the touch screen 22 by using the touch screen 22 (step S402). When the touch operation is detected by the touch screen 22, the portable apparatus 20 detects a rotation angle and a rotation direction of the portable apparatus 20 relative to a reference axis perpendicular to the touch screen 22 by using the motion sensor 24 (step S404). After the rotation angle and the rotation direction are detected by the motion sensor 24, the processor 26 further determines whether the rotation angle is over a threshold (step S406). Steps S402 to S406 are the same as or similar to steps S302 to S306 in the previous embodiment, so the detailed contents are not repeated herein.

Different from the previous embodiment, in the present embodiment, the processor 26 continues to detect the rotation direction when determining that the rotation angle is over the threshold (S408). The rotation direction is determined according to a positive or a negative value of a rotation angle which is calculated by converting a yaw angular velocity sensed by a gyro sensor into the rotation angle. That is, the rotation angle calculated as positive represents the clockwise rotation direction, and the rotation angle calculated as negative represents the counterclockwise rotation direction.

It should be mentioned that when determining that the rotation direction is clockwise, the processor 26 proportionally adjusts the size of the window according to the square area formed by the touch position and the right-side edge and the lower edge of the touch screen 22, such that the adjusted window is located within the square area, and the height or the width of the adjusted window is identical to that of the square area (step S410). Relatively, when determining that the rotation direction is counterclockwise, the processor 26 proportionally adjusts the size of the window according to the square area formed by the touch position and the left-side edge and the lower edge of the touch screen 22, such that the adjusted window is located within the square area, and the height or the width of the adjusted window is identical to that of the square area (step S412).

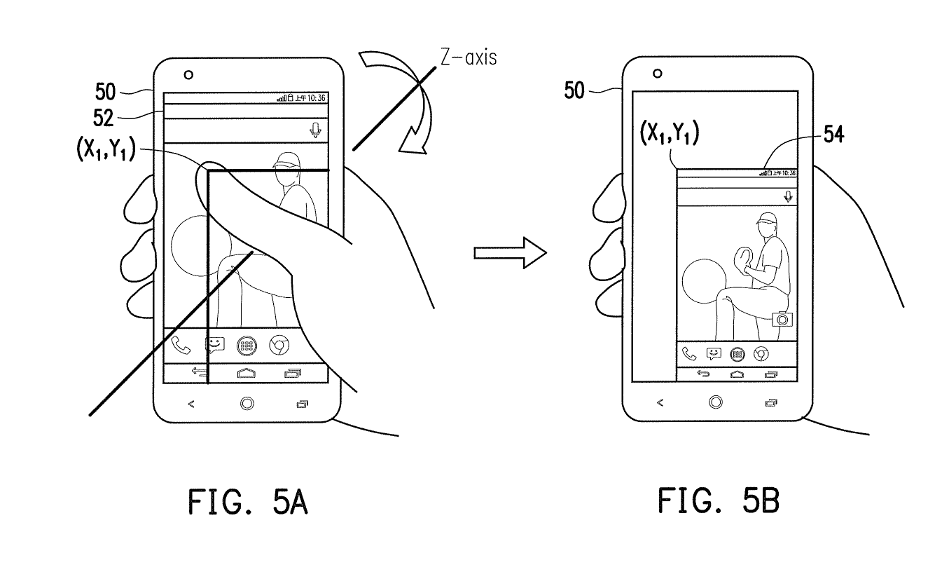

For example, FIG. 5A and FIG. 5B illustrate an example of adjusting a window size according to an embodiment of the invention. Referring to FIG. 5A first, when the user touches a position (X₁, Y₁) on a touch screen of a portable apparatus 50, the portable apparatus 50 detects a rotation angle and a rotation angle relative to the Z-axis perpendicular to the touch screen. When the user wobbles the portable apparatus 50 clockwise for more than 30 degrees, the portable apparatus 50 adjusts the original window 52 to be located within a square area formed by the touch position (X₁, Y₁) and the right-side ledge and the lower ledge of the touch screen, and thereby, an adjusted window 54 as shown in FIG. 5B is presented.

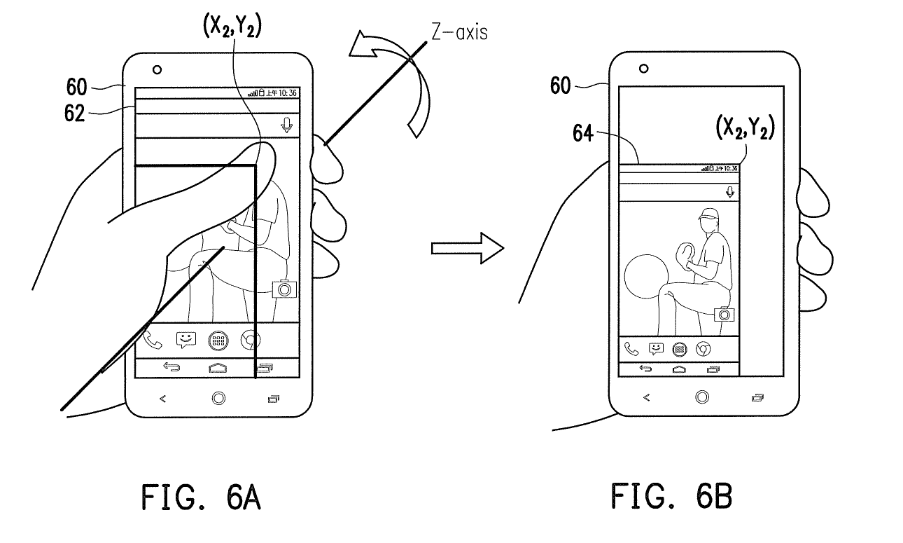

On the other hand, FIG. 6A and FIG. 6B illustrate an example of adjusting a window size according to an embodiment of the invention. Referring to FIG. 6A first, when the user touches a position (X₂, Y₂) on a touch screen of a portable apparatus 60, the portable apparatus 60 detects a rotation angle and a rotation angle relative to the Z-axis perpendicular to the touch screen. When the user wobbles the portable apparatus 60 counterclockwise for more than 30 degrees, the portable apparatus 60 adjusts the original window 62 to be located within a square area formed by the touch position (X₂, Y₂) and the left-side ledge and the lower ledge of the touch screen, and thereby, an adjusted window 64 as shown in FIG. 6B is presented.

By the above-described method, the user is able to adjust the window to a desired size quickly in a scenario of one-hand operation only through the use of simply touch and wobbling gestures, which is convenient for the user to operate the portable apparatus with one single hand. Moreover, the user may repeat the above-described operation steps to adjust the window to a desired size.

It should be mentioned that in addition to the method for adjusting the window size above, the invention also provide a method for recovering the window size. The difference between the method for recovering the window size and the method for adjusting the window size lies in that the user may touch any point on the touch screen and wobble the portable apparatus in a direction reversed to the direction that the user previously wobbles the portable apparatus.

In detail, after adjusting the size of the window displayed on the touch screen according to the touch position of the user's touch operation and the rotation direction, the processor continues to detect another touch operation performed by the user on the touch screen, when another touch operation is detected by the touch screen, another rotation angle and another rotation direction relative to the reference axis perpendicular to the touch screen are detected by using the motion sensor 24, and whether such rotation angle is reversed to the rotation angle detected previously in the operation of adjusting the window and over the threshold is determined. When such rotation angle is reversed to the rotation angle detected previously in the operation of adjusting the window and over the threshold, the processor adjusts the size of the window back to the original size. For example, if the user previously adjusts the size of the window by pressing the touch screen and rotating the portable apparatus clockwise, the previously adjusted window will be recovered to the original size when the user again presses the touch screen and rotate the portable apparatus counterclockwise.

To sum up, the portable apparatus and the method for adjusting the window size thereof combines the touch operations of the user with the wobbling gestures of the portable apparatus. Thereby, even when operating a large-size touch screen, the user still can adjust the window size with one hand and adjust the window to a desired size in one-time operation. Thereby, the user can conveniently operate a portable apparatus with a large-size touch screen with one hand.

Although the invention has been disclosed by the above embodiments, they are not intended to limit the invention. It will be apparent to one of ordinary skill in the art that modifications and variations to the invention may be made without departing from the spirit and scope of the invention. Therefore, the scope of the invention will be defined by the appended claims.

What is claimed is:

1. A method for adjusting a window size, adapted for a portable apparatus having a touch screen and a motion sensor, comprising:
detecting a touch operation performed on the touch screen;
detecting a rotation angle and a rotation direction of the portable apparatus relative to a reference axis perpendicular to the touch screen by using the motion sensor when the touch operation is detected, and determining whether the rotation angle is over a threshold; and
adjusting a size of a window displayed on the touch screen according to a touch position of the touch operation and the rotation direction when the rotation angle is over the threshold.

2. The method according to claim 1, wherein the step of adjusting the size of the window displayed on the touch screen according to the touch position of the touch operation and the rotation direction comprises:
proportionally adjusting the size of the window according to a square area formed by the touch position and a side edge and a lower edge of the touch screen, such that the adjusted window is located within the square area and has a height identical to a height of the square area or has a width identical to a width of the square area.

3. The method according to claim 2, wherein the side edge is the side edge of the touch screen on the rotation direction or the side edge having a longer distance away from the touch position.

4. The method according to claim 1, wherein the step of adjusting the size of the window displayed on the touch screen according to the touch position of the touch operation and the rotation direction further comprises:
continuing to detect another touch operation performed on the touch screen;
detecting another rotation angle and another rotation direction of the portable apparatus relative to the reference axis perpendicular to the touch screen by using the motion sensor when said another touch operation is detected, and determining whether said another rotation angle is reversed to the rotation angle and over the threshold; and
when said another rotation angle is reversed to the rotation angle and over the threshold, adjusting the size of the window back to an original size.

5. The method according to claim 1, wherein when the touch operation is detected, the method further comprises:
determining whether the touch operation is located within a predetermined area; and
detecting the rotation angle and the rotation direction of the portable apparatus relative to the reference axis perpendicular to the touch screen by using the motion sensor only when the touch operation is within the predetermined area.

6. The method according to claim 5, wherein the predetermined area comprises a screen to be unlocked, an area except for at least one touchable object in a locked screen, or a screen of a specific application.

7. The method according to claim 1, wherein the touch operation comprises one or a combination of a single-click, a double-click and a long press.

8. The method according to claim 1, wherein the threshold ranges from 30 to 45 degrees.

9. A mobile apparatus, comprising:
a touch screen, detecting a touch operation and displaying a window;
a motion sensor, detecting a rotation angle and a rotation direction of the portable apparatus relative to a reference axis perpendicular to the touch screen; and
a processor, coupled to the touch screen and the motion sensor, determining whether the rotation angle detected by the motion sensor is over a threshold when the touch operation is detected by the touch screen, and adjusting a size of a window displayed on the touch screen according to a touch position of the touch operation and the rotation direction when the rotation angle is over the threshold,.

10. The portable apparatus according to claim 9, wherein the processor proportionally adjusts the size of the window according to a square area formed by the touch position and a side edge and a lower edge of the touch screen, such that the adjusted window is located within the square area and has a height identical to a height of the square area or has a width identical to a width of the square area, wherein the side edge is the side edge on the rotation direction or the side edge having a longer distance away from the touch position.

11. The portable apparatus according to claim 9, wherein the processor further determines whether another rotation angle detected by the motion sensor is reversed to the rotation angle and over the threshold when another touch operation performed on the touch screen is detected, and adjusts the size of the window back to the original size when said another rotation angle is reversed to the rotation angle and over the threshold.

12. The portable apparatus according to claim 9, wherein the processor further determines whether the touch operation is located within a predetermined area when the touch operation is detected by the touch screen and detects the rotation angle and the rotation direction of the portable apparatus relative to the reference axis perpendicular to the touch screen by using the motion sensor when the touch operation is within the predetermined area, wherein the predetermined area comprises a screen to be unlocked, an area except for at least one touchable object in a locked screen, or a screen of a specific application.

13. The portable apparatus according to claim 9, wherein the touch operation comprises one or a combination of a single-click, a double-click and a long press.

14. The portable apparatus according to claim 9, wherein the threshold ranges from 30 to 45 degrees.

15. The portable apparatus according to claim 9, wherein the motion sensor comprises one or a combination of a gravity sensor (G-sensor), a magnetic sensor, a gyro sensor and an electronic compass.
